(19) United States
(12) Patent Application Publication
(10) Pub. No.: US 2025/0334137 A1
(43) Pub. Date: Oct. 30, 2025

(54) CONNECTING ROD PIECE

(71) Applicant: YONG SONG, Hangzhou City (CN)

(72) Inventor: YONG SONG, Hangzhou City (CN)

(21) Appl. No.: 19/247,261

(22) Filed: Jun. 24, 2025

(30) Foreign Application Priority Data
Apr. 24, 2024 (CN) 202420854617.9

(51) Int. Cl. F16B 7/04; A47H 1/02; A47H 13/00

(52) U.S. Cl. CPC F16B 7/0433; A47H 1/02; A47H 13/00; A47H 2001/0215

(57) ABSTRACT

A connecting rod piece includes a hollow first connecting rod unit, a connecting device, a hollow second connecting rod unit, a first locking member and a second locking member. A side wall of the first connecting rod unit is provided with a first mounting slot. The connecting device has a first end and a second end. A side wall of the second connecting rod unit is provided with a second mounting slot. The first locking member detachably locks the first end of the connecting device to the first connecting rod unit. The second locking member detachably locks the second end of the connecting device to the second connecting rod unit. When the connecting rod piece needs to be mounted, the first connecting rod unit and the second connecting rod unit can be combined into a whole through the connecting device.

### CROSS-REFERENCE TO RELATED APPLICATION

The application claims priority of Chinese patent application CN202420854617.9, filed on Apr. 24, 2024, which is incorporated herein by reference in its entirety.

### TECHNICAL FIELD

The present disclosure relates to the technical field of curtains, and in particular, to a connecting rod piece.

### BACKGROUND

There are curtains and connecting rod pieces for curtains currently available on the market, and the connecting rod pieces are all integrally formed, so the connecting rod pieces are relatively long, which are inconvenient for transportation and mounting, causing high transportation and mounting costs and great troubles. Therefore, there is an urgent need to provide a connecting rod piece that is convenient to mount and transport on the market to improve the user experience.

### SUMMARY

In order to overcome the shortcomings of the prior art, the present disclosure provides a connecting rod piece, including:
a hollow first connecting rod unit, wherein a side wall of the first connecting rod unit is provided with a first mounting slot;
a connecting device, wherein the connecting device has a first end and a second end;
a hollow second connecting rod unit, wherein a side wall of the second connecting rod unit is provided with a second mounting slot; the first end of the connecting device is detachably connected to the first connecting rod unit, and the second end of the connecting device is detachably connected to the second connecting rod unit; the first mounting slot and the second mounting slot are communicated in sequence to form a mounting channel; the mounting channel is configured to mount a curtain;

The present disclosure has the beneficial effects: The present disclosure provides a connecting rod piece. The connecting rod piece includes: a hollow first connecting rod unit, wherein a side wall of the first connecting rod unit is provided with a first mounting slot; a connecting device, wherein the connecting device has a first end and a second end; a hollow second connecting rod unit, wherein a side wall of the second connecting rod unit is provided with a second mounting slot; the first end of the connecting device is detachably connected to the first connecting rod unit, and the second end of the connecting device is detachably connected to the second connecting rod unit; the first mounting slot and the second mounting slot are communicated in sequence to form a mounting channel; the mounting channel is configured to mount a curtain. By the above structure, when the connecting rod piece needs to be mounted, the first connecting rod unit and the second connecting rod unit can be combined into a whole through the connecting device, and then the curtain is mounted in the mounting channel to implement mounting of the curtain and the connecting rod piece. If a short curtain needs to be mounted, the first connecting rod unit and the second connecting rod unit can be connected without using the connecting device, so that it is convenient for a user to separately use the first connecting rod unit and the second connecting rod unit to mount the curtains, to meet actual needs of the user in different scenarios.

### BRIEF DESCRIPTION OF THE DRAWINGS

To describe the technical solutions in the embodiments of the present disclosure more clearly, the following briefly introduces the accompanying drawings for describing the embodiments. The accompanying drawings in the following description show merely some embodiments of the present utility model, and a person of ordinary skill in the art may still derive other drawings from the accompanying drawings without creative efforts.

The present disclosure will be further explained below in conjunction with the accompanying drawings and embodiments.

FIG. 1 is a schematic diagram of an entire structure of the present disclosure;

FIG. 2 is an exploded view of the present disclosure;

FIG. 3 is an enlarged view of the part A in FIG. 2;

FIG. 4 is an enlarged view of the part B in FIG. 2;

FIG. 5 is a sectional view cut away along a first connecting rod unit, a second connecting rod unit, and a connecting device;

FIG. 6 is an enlarged view of the part C in FIG. 5;

FIG. 7 is a sectional view cut away along a first locking member, a first connecting rod unit, and a connecting device;

FIG. 8 is a sectional view cut away along a second locking member, a second connecting rod unit, and a connecting device;

FIG. 9 is a sectional view cut away along a third locking member and a connecting device;

FIG. 10 is another sectional view cut away along a first locking member, a first connecting rod unit, and a connecting device;

FIG. 11 is a schematic structural diagram of a weight reducing groove; and

FIG. 12 is a schematic structural diagram of a first gap and a second gap.

### DETAILED DESCRIPTION OF THE EMBODIMENTS

### Embodiment I

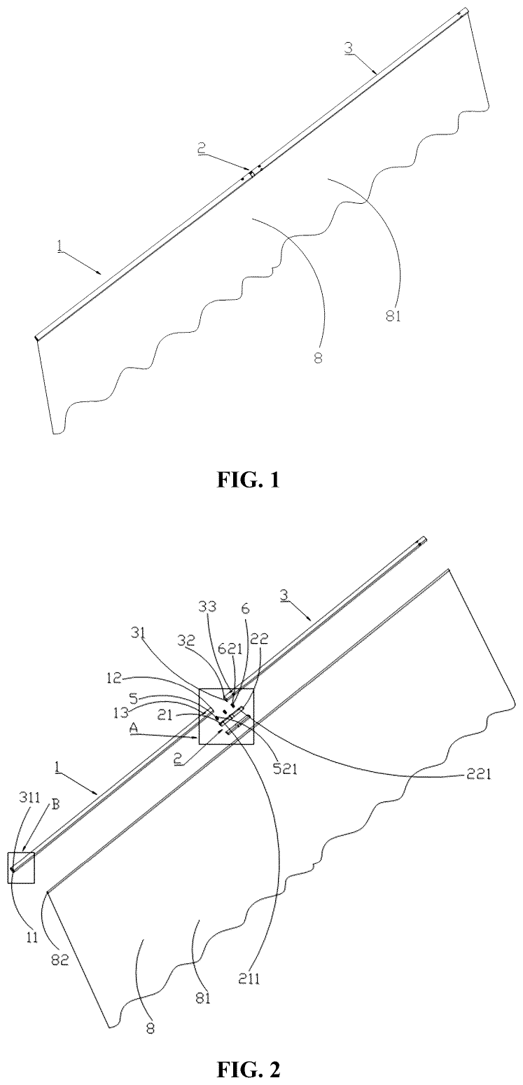

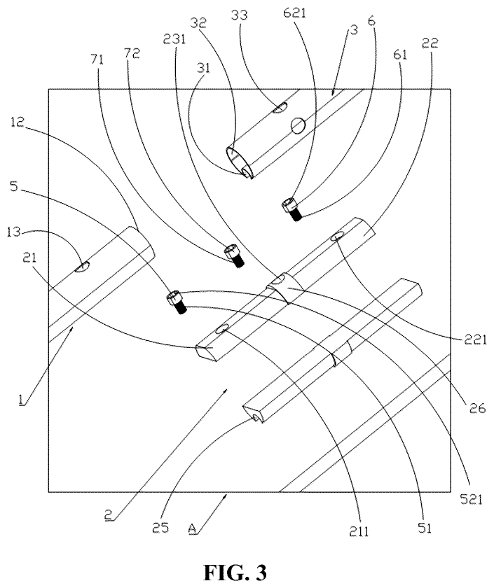

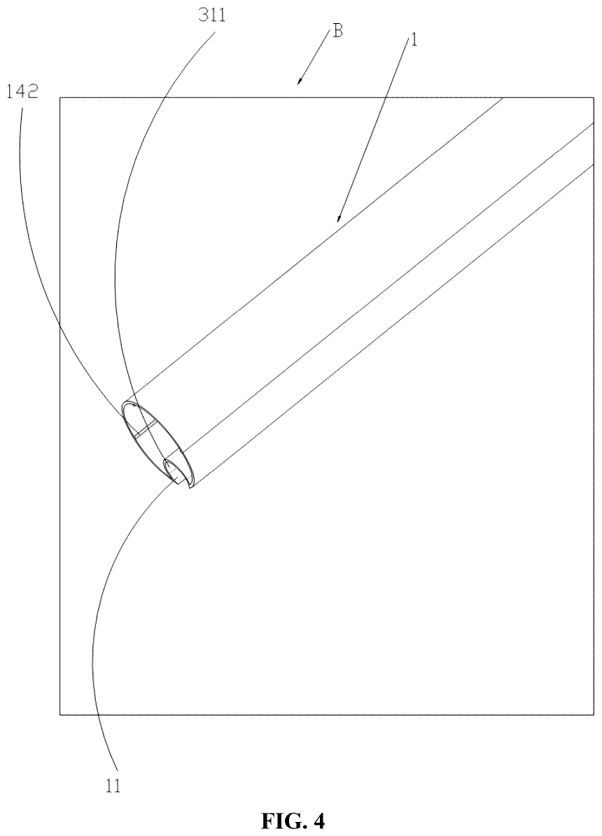

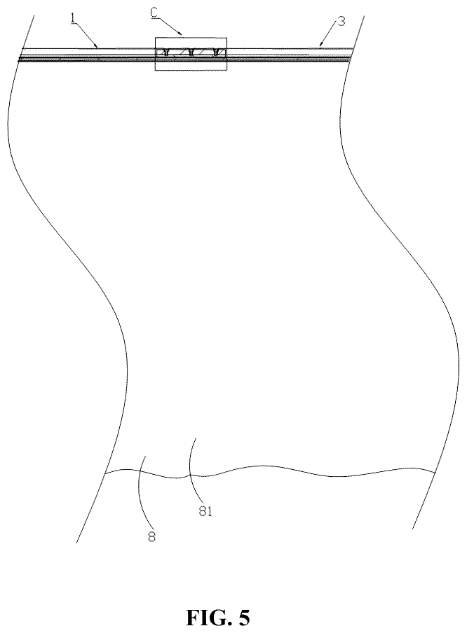

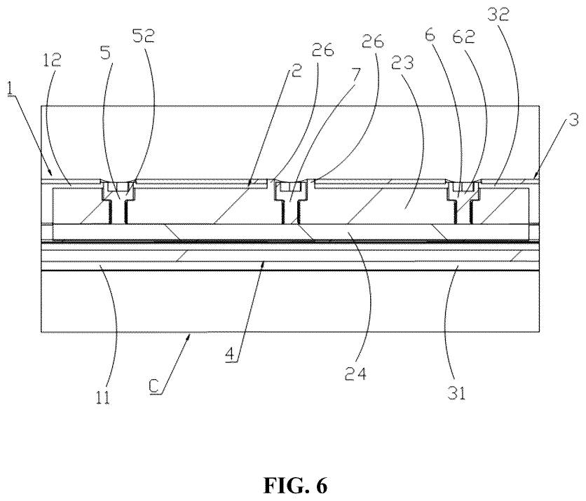

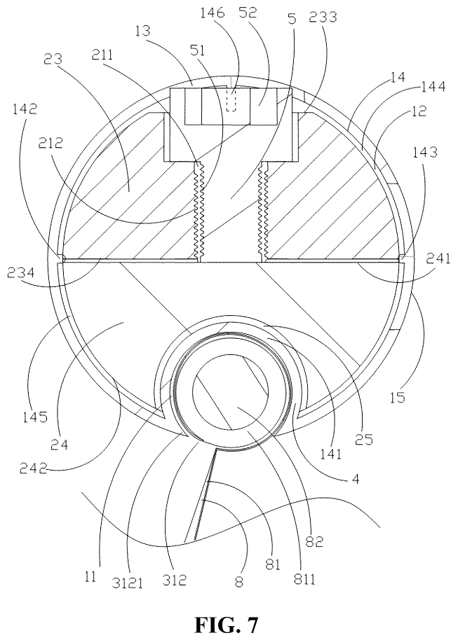

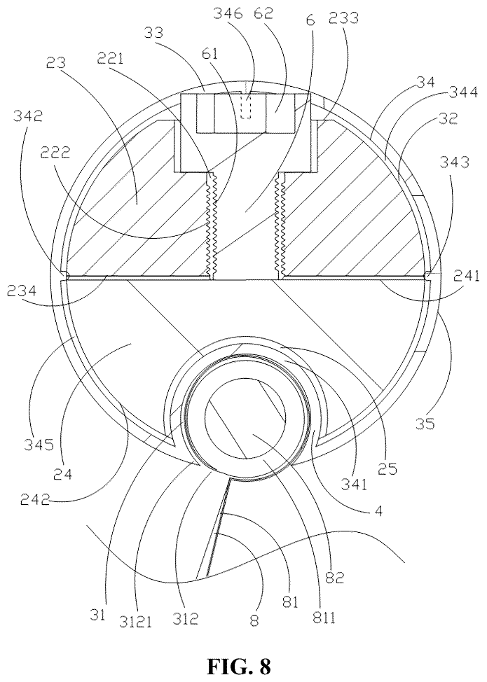

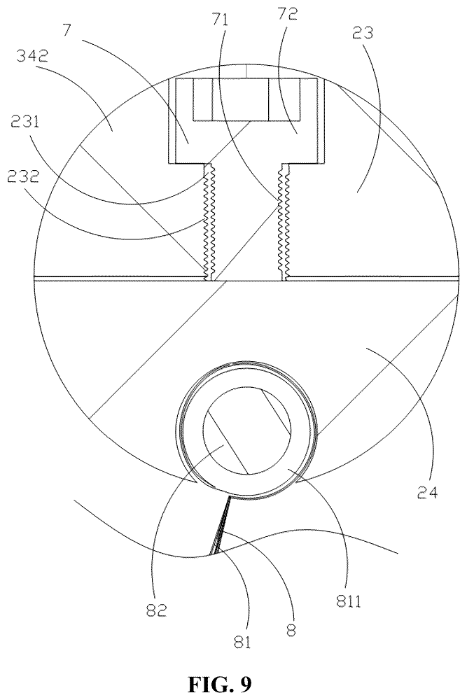

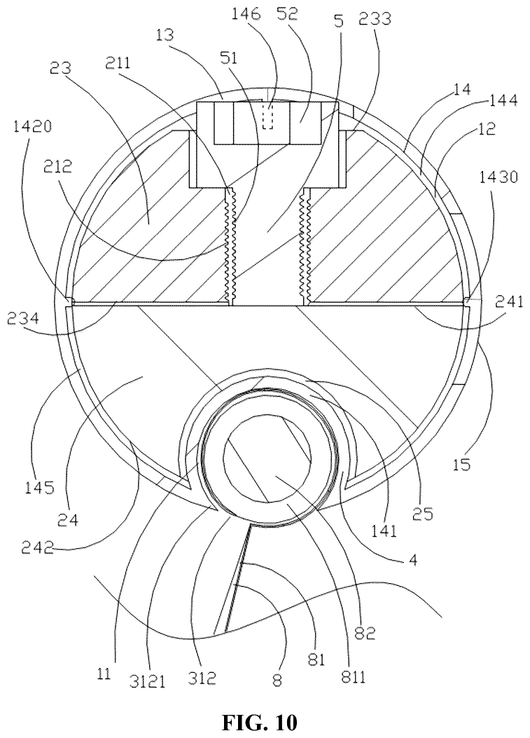

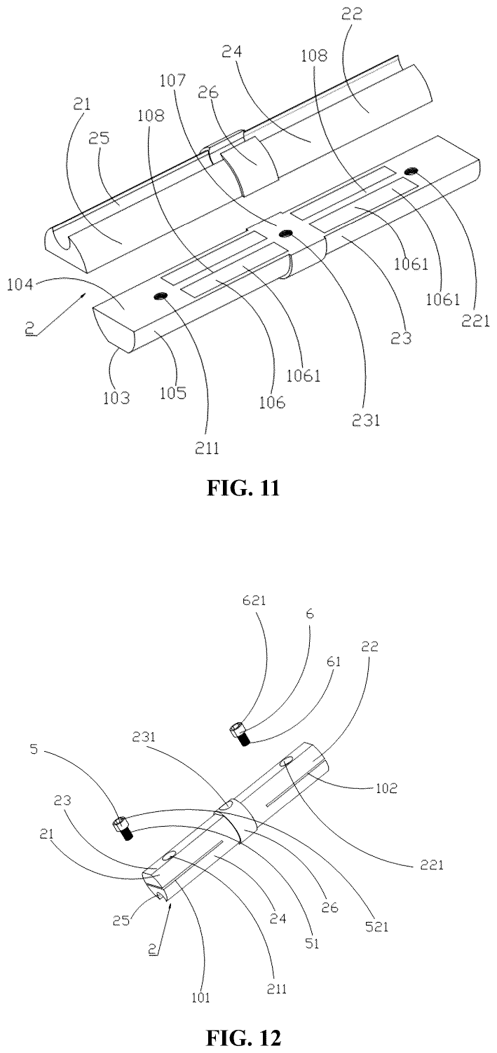

Referring to FIG. 1 to FIG. 12, a connecting rod piece includes a hollow first connecting rod unit 1, a connecting device 2, and a hollow second connecting rod unit 3.

A side wall of the first connecting rod unit 1 is provided with a first mounting slot 11. The connecting device 2 has a first end 21 and a second end 22.

A side wall of the second connecting rod unit 3 is provided with a second mounting slot 31; the first end 21 of the connecting device 2 is detachably connected to the first connecting rod unit 1, and the second end 22 of the connecting device 2 is detachably connected to the second connecting rod unit 3; the first mounting slot 11 and the second mounting slot 31 are communicated in sequence to form a mounting channel 4; and the mounting channel 4 is configured to mount a curtain 8. By the above structure, when the connecting rod piece needs to be mounted, the first connecting rod unit and the second connecting rod unit can be combined into a whole through the connecting device, and then the curtain is mounted in the mounting channel to implement mounting of the curtain and the connecting rod piece. If a short curtain needs to be mounted, the first connecting rod unit and the second connecting rod unit can be connected without using the connecting device, so that it is convenient for a user to separately use the first connecting rod unit and the second connecting rod unit to mount the curtains, to meet actual needs of the user in different scenarios.

In this embodiment, the first connecting rod unit 1 has a first inner surface 14 and a first outer surface 15. A first protrusion 1420 and a second protrusion 1430 are arranged on the first inner surface 14 in a protruding manner. The first protrusion and the second protrusion are respectively located on left and right sides of the first inner surface 14. By the above structure, the first protrusion 1420 and the second protrusion 1430 that are arranged on the first inner surface 14 can improve strength of the connecting rod piece. A thickness range of the first protrusion is 0.5 to 10 mm, and a height range of the first protrusion is 0.5 to 10 mm. Specifically, the thickness range of the first protrusion is 1 to 3 mm, and the height range of the first protrusion is 1 to 3 mm.

In this embodiment, the connecting device 2 includes an upper half part 23 and a lower half part 24. A first positioning slot 144 is formed among the first positioning protrusion, the second positioning protrusion, and an upper side of the first inner surface 14. A second positioning slot 145 is formed among the first positioning protrusion, the second positioning protrusion, and a lower side of the first inner surface 14. One end of the upper half part 23 is inserted into the first positioning slot 144, and one end of the lower half part 24 is inserted into the second positioning slot 145. By the above structure, due to the arrangement of the first positioning slot 144 and the second positioning slot 145, it can be convenient for a user to precisely and quickly mount the upper half part 23 and the lower half part 24 on the first connecting rod unit 1.

In this embodiment, the connecting device 2 includes an upper half part 23 and a lower half part 24. The connecting rod piece further includes a third locking member 7. One end of the third locking member 7 is provided with a third external thread 71, and another end of the third locking member 7 is provided with a third nut 72. The upper half part 23 is further provided with a fifth mounting hole 231. The fifth mounting hole 231 is internally provided with a third internal thread 232. The third external thread 71 is connected to the third internal thread 232, and one end of the third locking member 7 is compressed to the lower half part 24, to form a gap between the upper half part and the lower half part to compress the lower half part and the upper half part to an inner wall of the first connecting rod unit 1 and an inner wall of the second connecting rod unit 3. A stop protrusion 26 is further arranged on a side wall of the connecting device. The fifth mounting hole is provided in the stop protrusion. The fifth mounting hole 231 is located between the first mounting hole 211 and the second mounting hole 221. By the above structure, one end of the third locking member 7 is compressed to the lower half part 24 to form a gap between the upper half part and the lower half part, so as to compress the lower half part and the upper half part to the inner wall of the first connecting rod unit 1 and the inner wall of the second connecting rod unit 3, to closely connect the lower half part 24 to the first connecting rod unit 1 and the second connecting rod unit 3. This can not only prevent the lower half part 24 from being loosened from the first connecting rod unit 1 and the second connecting rod unit 3, but also prevent the lower half part from shaking. Furthermore, the fifth mounting hole is provided in the stop protrusion, and the stop protrusion may not be inserted into the first connecting rod unit and the second connecting rod unit, so that the fifth mounting hole cannot be blocked by the first connecting rod unit and the second connecting rod unit, and then it is convenient for a user to adjust the gap between the upper half part and the lower half part by turning the third locking member, thus compressing the lower half part and the upper half part to the inner wall of the first connecting rod unit 1 and an inner wall of the second connecting rod unit 3.

In this embodiment, the first connecting rod unit 1 has a first mounting opening 12. The second connecting rod unit 3 has a second mounting opening 32. The first end 21 of the connecting device 2 is inserted into the first mounting opening 12, and the second end 22 of the connecting device 2 is inserted into the second mounting opening 32, to enable the connecting device 2 to combine the first connecting rod unit 1 with the second connecting rod unit 3 into a whole. A stop protrusion 26 is further arranged on a side wall of the connecting device. The stop protrusion is located between the first end and the second end. One side of the stop protrusion 26 is stopped at the first mounting opening 12, and another side of the stop protrusion 26 is stopped at the second mounting opening 32. By the above structure, precise connection between the connecting device 2 and the first connecting rod unit 1, as well as the second connecting rod unit 3, is effectively implemented, which prevents the connecting device 2 from being excessively inserted into the first mounting opening or the second mounting opening 32.

In this embodiment, a length of the first end and a length of the second end are both greater than a length of the stop protrusion; and a width of the first end and a width of the second end are both less than a width of the stop protrusion. By the above structure, the width of the first end and the width of the second end are both less than the width of the stop protrusion, so that the first end and the second end can be smoothly inserted into the first mounting opening and the second mounting opening, and the stop protrusion can be prevented from being inserted into the first mounting opening or the second mounting opening 32. Furthermore, since the length of the first end and the length of the second end are both greater than the length of the stop protrusion, the first end and the second end that are inserted into the first connecting rod unit and the second connecting rod unit have large lengths, which can improve connection strength and make the stop protrusion that is not inserted have a small length. This can effectively improve the overall strength of the connection rod piece, so that a moment of the stop protrusion is reduced, and breakage of the stop protrusion is prevented. For example, since the strength of the connecting device itself is lower than that of the first connecting rod unit and that of the second connecting rod unit, if the length of the stop protrusion is set to be too large, a moment of the exposed stop protrusion becomes longer, causing the stop protrusion to be easily broken. For another example, when the first end and the second end are set to be short, it is easy for the first end and the second end to be separated from the first connecting rod unit and the second connecting rod unit, making the connection unstable.

In this embodiment, a length range of the connecting device is 5 mm to 500 mm; a width range of the connecting device is 10 mm to 60 mm; and a length range of the stop protrusion is 1 mm to 80 mm. The length range of the connecting device is 10 mm to 300 mm; the width range of the connecting device is 20 mm to 50 mm; and the length range of the stop protrusion is 10 mm to 30 mm. By the above structure, the dimension settings are proper. The connecting device within the dimension ranges can stably splice the first connecting rod unit with the second connecting rod unit, and the moment of the stop protrusion within the dimension ranges is small, so that the stop protrusion can achieve a stop effect and is not easily broken.

In this embodiment, the connecting device 2 includes an upper half part 23 and a lower half part 24. The upper half part and/or the lower half part has a weight reducing groove 106. By the above structure, due to the weight reducing groove in the upper half part and/or the lower half part, the weight of the connecting device itself can be reduced, making it convenient to transport and mount the connecting rod piece. For example, when the first connecting rod unit and the second connecting rod unit are thick, the connecting device for connecting the first connecting rod unit to the second connecting rod unit becomes thicker. As a result, the connecting device is heavier. To solve this problem, providing the weight reducing groove in the upper half part and/or the lower half part can effectively reduce the weight of the connecting device itself, so as to facilitate the transportation and mounting of the connecting rod piece.

In this embodiment, a first reinforcing rib 107 is provided inside the weight reducing groove. The first reinforcing rib divides the weight reducing groove into at least two groove units 1061. The at least two groove units are arranged in sequence in a length direction of the connecting device. A second reinforcing rib 108 is provided inside the weight reducing groove. The first reinforcing rib and the second reinforcing rib are crosswise arranged. The first reinforcing rib and the second reinforcing rib divide the weight reducing groove into at least four groove units. The at least four groove units are arranged in sequence in length and width directions of the connecting device. By the above structure, the first reinforcing rib and the second reinforcing rib can improve the strength of the connecting device, solve a problem of a decrease in the strength of the connecting device due to the arrangement of the weight reducing groove, make the connecting device still have high connection strength in a weight-reduced state, and prevent the connecting device from being broken or being compressed to collapse.

In this embodiment, a thickness range of the first reinforcing rib is 1 mm to 40 mm; a length range of the weight reducing groove is 1 mm to 300 mm; a width range of the weight reducing groove is 1 mm to 300 mm; and a depth range of the weight reducing groove is 1 mm to 40 mm. A thickness range of the first reinforcing rib is 1 mm to 30 mm; a length range of the weight reducing groove is 1 mm to 200 mm; a width range of the weight reducing groove is 1 mm to 250 mm; and a depth range of the weight reducing groove is 1 mm to 20 mm. By the above structure and the proper dimension settings, the weight reducing groove within the dimension ranges can effectively reduce the weight of the connecting device, and the first reinforcing rib within the dimension ranges can effectively maintain the strength of the connecting device, so that the connecting device can still have high connection strength in the weight-reduced state, to prevent the connecting device from being broken or compressed to collapse.

In this embodiment, the connecting rod piece is an aluminum alloy connecting rod piece, an iron connecting rod piece, a plastic connecting rod piece, a stainless steel connecting rod piece, a copper connecting rod piece, a zinc alloy connecting rod piece, a copper alloy connecting rod piece, an alloy steel connecting rod piece, or an aluminum-plastic composite connecting rod piece; and the connecting device is a plastic connecting device or a metal connecting device. Specifically, the connecting rod piece is the aluminum alloy connecting rod piece, the iron connecting rod piece, the plastic connecting rod piece, the stainless steel connecting rod piece, the zinc alloy connecting rod piece, or the copper alloy connecting rod piece. By the above structure, the connecting rod piece has high strength and is not easily broken. Furthermore, the aluminum alloy connecting rod piece, the plastic connecting rod piece, the stainless steel connecting rod piece, the zinc alloy connecting rod piece, or the copper alloy connecting rod piece are not easily rusted, so that the connecting rod piece can be used in a wet environment such as a bathroom. Specifically, a metal connecting rod piece has high connection strength and is not easily broken.

In this embodiment, a length of the first connecting rod unit and a length of the second connecting rod unit are both greater than a length of the connecting device. A sum of a weight of the first connecting rod unit and a weight of the second connecting rod unit is greater than a weight of the connecting device. By the above structure, since the length of the first connecting rod unit and the length of the second connecting rod unit are both greater than the length of the connecting device, the connecting device can play a role in extending the connecting rod, to meet a need of a user for mounting a large-size curtain. For example, if the length of the first connecting rod unit and the length of the second connecting rod unit are set to be less than or equal to the length of the connecting device, the connecting device may lose its purpose of connection and splicing, and the curtain can be hung by directly using the connecting device. Moreover, since the sum of the weight of the first connecting rod unit and the weight of the second connecting rod unit is greater than the weight of the connecting device, the weight of the connecting device that plays a splicing role has a small proportion, which is convenient for transportation and can increase the length of the connecting rod piece as much as possible within an effective weight range.

In this embodiment, hardness of the first connecting rod unit and hardness of the second connecting rod unit are greater than hardness of the connecting device. By the above structure, since the hardness of the first connecting rod unit and the hardness of the second connecting rod unit are greater than the hardness of the connecting device, the connecting device can be effectively prevented from tearing the first connecting rod unit and the second connecting rod unit. For example, when the hardness of the connecting device is greater than or equal to the hardness of the first connecting rod unit and the hardness of the second connecting rod unit, one end of the third locking member 7 is compressed to the lower half part 24 to form a gap between the upper half part and the lower half part, so as to compress the lower half part and the upper half part to the inner wall of the first connecting rod unit 1 and the inner wall of the second connecting rod unit 3. If a user excessively turns the third locking member, a large gap is formed between the upper half part and the lower half part, and the lower half part and the upper half part excessively press against the inner wall of the first connecting rod unit 1 and the inner wall of the second connecting rod unit 3, which can easily cause the connecting device to tear the first connecting rod unit and the second connecting rod unit. Therefore, since the hardness of the first connecting rod unit and the hardness of the second connecting rod unit are set to be greater than the hardness of the connecting device, the connecting device can be effectively prevented from tearing the first connecting rod unit and the second connecting rod unit.

In this embodiment, a ratio of a length of the first connecting rod unit to a length of the connecting device is at least 1:1, and a ratio of a length of the second connecting rod unit to a length of the connecting device is at least 1:1. The ratio of the length of the first connecting rod unit to the length of the connecting device is at least 3:1, and the ratio of the length of the second connecting rod unit to the length of the connecting device is at least 3:1. By the above structure, the connecting device can play a role of extending the connecting rod piece to meet a need of a user for mounting a large-size curtain. For example, if the ratios of the length of the first connecting rod unit and the length of the second connecting rod unit to the length of the connecting device are set to be too small, the connecting device may lose its purpose of connection and splicing, and the curtain can be hung by directly using the connecting device.

In this embodiment, an inner diameter range of the first mounting opening is 20 mm to 80 mm; a width of the stop protrusion is greater than an inner diameter of the first mounting opening; a length of the first connecting rod unit is greater than a length of the first end, to enable the first connecting rod unit to completely wrap around the first end; a length of the second connecting rod unit is greater than a length of the second end, to enable the second connecting rod unit to completely wrap around the second end; and when the connecting device 2 combines the first connecting rod unit 1 with the second connecting rod unit 3 into a whole, a length of the connecting rod piece is at least a sum of the length of the first connecting rod unit, the length of the second connecting rod unit, and the length of the stop protrusion. By the above structure, the first connecting rod unit can completely wrap around the first end to prevent the first end from being exposed, thereby preventing the first end from being partially broken due to exposure, and also making the overall appearance of the connecting rod piece more beautiful. Further, the first mounting opening within this inner diameter range can better accommodate the connecting device, and the thickness of the connecting device can be set to be more proper. For example, if the first mounting opening is set to be too small, the connecting device can only be set to be thinner. A thin connecting device has low strength and is easily broken, which poses a significant safety hazard. For another example, if the first mounting opening is set to be too large, the connecting device can only be set to be thicker. A thick connecting device is heavy, resulting in high transportation costs. Still further, when the connecting device 2 combines the first connecting rod unit 1 with the second connecting rod unit 3 into a whole, the length of the connecting rod piece is at least the sum of the length of the first connecting rod unit, the length of the second connecting rod unit, and the length of the stop protrusion, so that the stop part can also play an extending role to increase the length of the connecting rod piece. Specifically, the inner diameter range of the first mounting opening is 20 mm to 60 mm.

In this embodiment, the weight reducing groove is square, rectangular, circular, elliptical, triangular, semicircular, polygonal, star-shaped, heart-shaped, or steplike. By the above structure, weight reducing grooves in various shapes can meet usage needs of different users, and the weight reducing grooves can be expanded or contracted according to actual needs.

In this embodiment, the connecting device 2 includes an upper half part 23 and a lower half part 24. The lower half part is provided with a first guide slot 25. The first mounting slot 11, the first guide slot 25, and the second mounting slot 31 are communicated in sequence to form the mounting channel 4. The mounting channel 4 is configured to mount the curtain 8. A thickness of a middle portion of the lower half part is less than a thickness on each of two sides of the lower half part. By the above structure, since the thickness of the middle portion of the lower half part is less than the thickness of each of the two sides of the lower half part, the lower half part can be better matched with the shape of the first mounting slot and the shape of the second mounting slot, to facilitate the mounting of the connecting device with the first connecting rod unit and the second connecting unit.

In this embodiment, the connecting device 2 includes an upper half part 23 and a lower half part 24. The upper half part has a weight reducing groove; and the lower half part is a solid lower half part. By the above structure, due to the weight reducing groove in the upper half part, the weight of the connecting device can be reduced. Moreover, since the lower half part is the solid lower half part, it can facilitate the third locking member to press against the lower half part to compress the lower half part to the inner wall of the first connecting rod unit and the inner wall of the second connecting rod unit. The upper half part has an upper surface 103, a lower surface 104, and a side surface 105. Both the upper surface and the lower surface are flat surfaces, and the side surface is an arc-shaped side surface.

In this embodiment, the first connecting rod unit 1 has a first mounting opening 12; the second connecting rod unit 3 has a second mounting opening 32; the first end 21 of the connecting device 2 is inserted into the first mounting opening 12, and the second end 22 of the connecting device 2 is inserted into the second mounting opening 32, to enable the connecting device 2 to combine the first connecting rod unit 1 with the second connecting rod unit 3 into a whole. The connecting device 2 includes an upper half part 23 and a lower half part 24; a middle portion of the upper half part is connected to a middle portion of the lower half part; a first gap 101 exists between one end of the upper half part and one end of the lower half part; a second gap 102 exists between another end of the upper half part and another end of the lower half part; a first mounting hole 211 is provided in the first end 21 of the connecting device 2; a second mounting hole 221 is provided in the second end 22 of the connecting device 2; a third mounting hole 13 is provided in the first connecting rod unit 1; and a fourth mounting hole 33 is provided in the second connecting rod unit 3. The connecting rod piece further includes a first locking member 5. The first locking member 5 detachably locks the first end 21 of the connecting device 2 to the first connecting rod unit 1. The connecting rod piece further includes a second locking member 6. The second locking member 6 detachably locks the second end 22 of the connecting device 2 to the second connecting rod unit 3. The first mounting hole 211 has a first internal thread 212 inside. The second mounting hole 221 has a second internal thread 222 inside; one end of the first locking member 5 has a first external thread 51; one end of the second locking member 6 has a second external thread 61; and when the first external thread 51 of the first locking member 5 passes through the third mounting hole 13 and the first mounting hole 211 in sequence and is connected to the first internal thread 212, one end of the first locking member 5 compresses the upper half part 23 to the lower half part 24, to expand the first gap between the upper half part and the lower half part to compress the lower half part and the upper half part to an inner wall of the first connecting rod unit 1. When the second external thread 6 of the second locking member 61 passes through the fourth mounting hole 33 and the second mounting hole 221 in sequence and is connected to the second internal thread 222, one end of the second locking member 6 compresses the upper half part 23 to the lower half part 24, to expand the second gap between the upper half part and the lower half part to compress the lower half part and the upper half part to an inner wall of the second connecting rod unit 3. By the above structure, since the middle portion of the upper half part and the middle portion of the lower half part, the overall strength of the connecting device is higher. Furthermore, one end of the first locking member 5 compresses the lower half part 24 to the lower half part 24, to expand the first gap between the upper half part and the lower half part to compress the lower half part and the upper half part to the inner wall of the first connecting rod unit 1. One end of the second locking member 6 compresses the lower half part 24 to the lower half part 24, to expand the second gap between the upper half part and the lower half par to compress the lower half part and the upper half part to the inner wall of the second connecting rod unit 3. This effectively connects the first end to the first connecting rod unit and the second end to the second connecting rod unit. The connection is stable. The connecting device tightly presses against the first connecting rod unit and the second connecting rod unit and does not easily shake.

### Embodiment II

Referring to FIG. 1 to FIG. 12, a connecting rod piece includes:
a hollow first connecting rod unit 1, wherein a side wall of the first connecting rod unit 1 is provided with a first mounting slot 11;
a connecting device 2, wherein the connecting device 2 has a first end 21 and a second end 22;
a hollow second connecting rod unit 3, wherein a side wall of the second connecting rod unit 3 is provided with a second mounting slot 31; the first end 21 of the connecting device 2 is detachably connected to the first connecting rod unit 1, and the second end 22 of the connecting device 2 is detachably connected to the second connecting rod unit 3; the first mounting slot 11 and the second mounting slot 31 are communicated in sequence to form a mounting channel 4; the mounting channel 4 is configured to mount a curtain 8;
a first locking member 5, wherein the first locking member 5 detachably locks the first end 21 of the connecting device 2 to the first connecting rod unit 1; and
a second locking member 6, wherein the second locking member 6 detachably locks the second end 22 of the connecting device 2 to the second connecting rod unit 3.

Through the above structure, the connecting rod piece includes: a hollow first connecting rod unit 1, wherein a side wall of the first connecting rod unit 1 is provided with a first mounting slot 11; a connecting device 2, wherein the connecting device 2 has a first end 21 and a second end 22; a hollow second connecting rod unit 3, wherein a side wall of the second connecting rod unit 3 is provided with a second mounting slot 31; the first end 21 of the connecting device 2 is detachably connected to the first connecting rod unit 1, and the second end 22 of the connecting device 2 is detachably connected to the second connecting rod unit 3; the first mounting slot 11 and the second mounting slot 31 are communicated in sequence to form a mounting channel 4; the mounting channel 4 is configured to mount a curtain 8; a first locking member 5, wherein the first locking member 5 detachably locks the first end 21 of the connecting device 2 to the first connecting rod unit 1; and a second locking member 6, wherein the second locking member 6 detachably locks the second end 22 of the connecting device 2 to the second connecting rod unit 3. When the connecting rod piece needs to be mounted, the first connecting rod unit 1 and the second connecting rod unit 3 can be combined into a whole through the connecting device 2, and then the curtain 8 is mounted in the first mounting slot 11 to achieve mounting of the curtain 8 and the connecting rod piece. When the connecting rod piece needs to be transported or stored, the curtain 8 can be separated from the first mounting slot 11, and the first connecting rod unit 1 can be separated from the second connecting rod unit 3, so as to reduce a length of the connecting rod, which reduces the packaging and logistics costs of the connecting rod piece during the transportation and greatly reduces the transportation cost of the connecting rod piece. Moreover, since the connecting device 2 connects the first connecting rod unit 1 to the second connecting rod unit 3, it is not only convenient for mounting and removal, but also achieves high connection strength. Further, the first locking member 5 detachably locks the first end 21 of the connecting device 2 to the first connecting rod unit 1, and the second locking member 6 detachably locks the second end 22 of the connecting device 2 to the second connecting rod unit 3, so that the stability of connection between the first connecting rod unit 1 and the second connecting rod unit 3 can be further improved, and the first connecting rod unit 1 and the second connecting rod unit 3 are prevented from being loosened from the connecting device 2.

In this embodiment, the first connecting rod unit 1 has a first mounting opening 12; the second connecting rod unit 3 has a second mounting opening 32; the first end 21 of the connecting device 2 is inserted into the first mounting opening 12, and the second end 22 of the connecting device 2 is inserted into the second mounting opening 32, to enable the connecting device 2 to combine the first connecting rod unit 1 with the second connecting rod unit 3 into a whole. Through the above structure, the design is reasonable, the structure is simple, and the connection is stable; detachable connection between the first connecting rod unit 1, as well as the second connecting rod unit 3, and the connecting device 2 is effectively achieved; and it is convenient for a user to mount and remove the connecting rod piece.

In this embodiment, the first end 21 of the connecting device 2 is provided with a first mounting hole 211; the second end 22 of the connecting device 2 is provided with a second mounting hole 221; the first connecting rod unit 1 is provided with a third mounting hole 13; the second connecting rod unit 3 is provided with a fourth mounting hole 33; and when the first end 21 of the connecting device 2 is inserted into the first connecting rod unit 1 through the first mounting opening 12, and the second end 22 of the connecting device 2 is inserted into the second connecting rod unit 3 through the second mounting opening 32, the first locking member 5 passes through the third mounting hole 13 and the first mounting hole 211 in sequence to lock the first end 21 of the connecting device 2 to the first connecting rod unit 1, and the second locking member 6 passes through the fourth mounting hole 33 and the second mounting hole 221 in sequence to lock the second end 22 of the connecting device 2 to the second connecting rod unit 3. The first mounting hole 211 is internally provided with a first internal thread 212; the second mounting hole 221 is internally provided with a second internal thread 222; one end of the first locking member 5 is provided with a first external thread 51; one end of the second locking member 6 is provided with a second external thread 61; the other end of the first locking member 5 is provided with a first nut 52; the other end of the second locking member 6 is provided with a second nut 62; when the first end 21 of the connecting device 2 is inserted into the first connecting rod unit 1 through the first mounting opening 12, and the second end 22 of the connecting device 2 is inserted into the second connecting rod unit 3 through the second mounting opening 32, the first external thread 51 of the first locking member 5 passes through the third mounting hole 13 and the first mounting hole 211 in sequence and is connected to the first internal thread 212; the first nut 52 is located in the third mounting hole 13; the first nut 52 can be pressed against an inner wall of the third mounting hole 13; the first end 21 of the connecting device 2 is stopped and locked in the first connecting rod unit 1; the second external thread 61 of the second locking member 6 passes through the fourth mounting hole 33 and the second mounting hole 221 in sequence and is connected to the second internal thread 222; the second nut 62 is located in the fourth mounting hole 33; the second nut 62 can be pressed against an inner wall of the fourth mounting hole 33; and the second end 22 of the connecting device 2 is stopped and locked in the second connecting rod unit 3. Specifically, the first nut 52 is provided with a first internal hexagonal mounting hole 521, and the second nut 62 is provided with a second internal hexagonal mounting hole 621. Through the above structure, the first external thread 51 of the first locking member 5 passes through the third mounting hole 13 and the first mounting hole 211 in sequence and is connected to the first internal thread 212; the first nut 52 is located in the third mounting hole 13; the first nut 52 can be pressed against an inner wall of the third mounting hole 13; the first end 21 of the connecting device 2 is stopped and locked in the first connecting rod unit 1, so as to prevent the first end 21 of the connecting device 2 from being separated from the first connecting rod unit 1, thereby achieving locking between the connecting device 2 and the first connecting rod unit 1 and combining the first connecting rod unit 1 with the connecting device 2 to form a whole. Furthermore, the second external thread 61 of the second locking member 6 passes through the fourth mounting hole 33 and the second mounting hole 221 in sequence and is connected to the second internal thread 222; the second nut 62 is located in the fourth mounting hole 33; the second nut 62 can be pressed against an inner wall of the fourth mounting hole 33; and the second end 22 of the connecting device 2 is stopped and locked in the second connecting rod unit 3, so as to prevent the second end 22 of the connecting device 2 from being separated from the second connecting rod unit 3, thereby achieving locking between the connecting device 2 and the second connecting rod unit 3 and combining the first connecting rod unit 1, the connecting device 2, and the second connecting rod unit 3 to form a whole.

In this embodiment, the connecting device 2 includes an upper half part 23 and a lower half part 24; the first mounting hole 211 and the second mounting hole 221 are both arranged at the upper half part 23; when the first external thread 51 of the first locking member 5 passes through the third mounting hole 13 and the first mounting hole 211 in sequence and is connected to the first internal thread 212, one end of the first locking member 5 compresses the lower half part 24 to the inner wall of the first connecting rod unit 1; and when the second external thread 61 of the second locking member 6 passes through the fourth mounting hole 33 and the second mounting hole 221 in sequence and is connected to the second internal thread 222, one end of the second locking member 6 compresses the lower half part 24 to the inner wall of the second connecting rod unit 3. The connecting rod piece further includes a third locking member 7; one end of the third locking member 7 is provided with a third external thread 71; the other end of the third locking member 7 is provided with a third nut 72; the upper half part 23 is further provided with a fifth mounting hole 231; the fifth mounting hole 231 is located between the first mounting hole 211 and the second mounting hole 221; the fifth mounting hole 231 is internally provided with a third internal thread 232; the third external thread 71 is connected to the third internal thread 232; and one end of the third locking member 7 is compressed to the lower half part 24. Through the above structure, one end of the first locking member 5 compresses the lower half part 24 to the inner wall of the first connecting rod unit 1, and one end of the second locking member 6 compresses the lower half part 24 to the inner wall of the second connecting rod unit 3, so that the lower half part 24 can be tightly connected to the first connecting rod unit 1 and the second connecting rod unit 3. This can not only prevent the lower half part 24 from being loosened from the first connecting rod unit 1 and the second connecting rod unit 3, but also prevent the lower half part from shaking. Furthermore, the first locking member 5 and the second locking member 6 compress the lower half part 24 to the first connecting rod unit 1 and the second connecting rod unit 3, so that no threaded hole needs to be formed in the lower half part 24. This can also shorten the first locking member 5, reduce the production cost, and facilitate a user to mount and remove the connecting rod piece.

In this embodiment, the first connecting rod unit 1 has a first inner surface 14 and a first outer surface 15; the first outer surface 15 is recessed towards the first inner surface 14 to form the first mounting slot 11 on the first outer surface 15 and to form a first guide protrusion 141 opposite to the first mounting slot 11 on the first inner surface 14; the second connecting rod unit 3 has a second inner surface 34 and a second outer surface 35; the second outer surface 35 is recessed towards the second inner surface 34 to form the second mounting slot 31 on the second outer surface 35 and to form a second guide protrusion 341 opposite to the second mounting slot 31 on the second inner surface 34; the connecting device 2 is provided with a first guide slot 25; the first guide slot 25 is connected to the first guide protrusion 141 and the second guide protrusion 341; the first mounting slot 11, the first guide slot 25, and the second mounting slot 31 are communicated in sequence to form the mounting channel 4; and the mounting channel 4 is configured to mount a curtain 8. Through the above structure, the first guide slot 25 is connected to the first guide protrusion 141 and the second guide protrusion 341, so that it can be convenient for a user to precisely connect the connecting device 2 to the first connecting rod unit 1 and the second connecting rod unit 3, and the mounting efficiency of the connecting rod piece is improved.

In this embodiment, a stop protrusion 26 is further arranged on a side wall of the connecting device 2; the stop protrusion is located between the first end and the second end; one side of the stop protrusion 26 is stopped at the first mounting opening 12; and the other side of the stop protrusion 26 is stopped at the second mounting opening 32. Through the above structure, precise connection between the connecting device 2 and the first connecting rod unit 1, as well as the second connecting rod unit 3, is effectively achieved, which prevents the connecting device 2 from being excessively inserted into the first mounting opening or the second mounting opening 32.

In this embodiment, the first mounting slot 11 extends from one end of the first connecting rod unit 1 to the other end of the first connecting rod unit 1, and the second mounting slot 31 extends from one end of the second connecting rod unit 3 to the other end of the second connecting rod unit 3; and the first guide slot 25 extends from the first end 21 of the connecting device 2 to the second end 22 of the connecting device 2. A first positioning protrusion 142 and a second positioning protrusion 143 are arranged on the first inner surface 14 in a protruding manner; the first positioning protrusion 142 and the second positioning protrusion 143 are respectively located on left and right sides of the first inner surface 14; a first positioning slot 144 is formed among the first positioning protrusion 142, the second positioning protrusion 143, and an upper side of the first inner surface 14; a second positioning slot 145 is formed among the first positioning protrusion 142, the second positioning protrusion 143, and a lower side of the first inner surface 14; one end of the upper half part 23 is inserted into the first positioning slot 144; one end of the lower half part 24 is inserted into the second positioning slot 145; a third positioning protrusion 342 and a fourth positioning protrusion 343 are arranged on the second inner surface 34 in a protruding manner; the third positioning protrusion 342 and the fourth positioning protrusion 343 are respectively located on left and right sides of the second inner surface 34; a third positioning slot 344 is formed among the third positioning protrusion 342, the fourth positioning protrusion 343, and an upper side of the second inner surface 34; a fourth positioning slot 345 is formed among the third positioning protrusion 342, the fourth positioning protrusion 343, and a lower side of the second inner surface 34; the other end of the upper half part 23 is inserted into the third positioning slot 344; and the other end of the lower half part 24 is inserted into the fourth positioning slot 345. Specifically, a fifth positioning protrusion 146 is further arranged on the upper side of the first inner surface 14, and a sixth positioning protrusion 346 is further arranged on the upper side of the second inner surface 34; when one end of the upper half part 23 is inserted into the first positioning slot 144, a bottom of the upper half part 23 is pressed against the first positioning protrusion 142 and the second positioning protrusion 143, and a top of the upper half part 23 is pressed against the fifth positioning protrusion 146; and when the other end of the upper half part 23 is inserted into the third positioning slot 344, the bottom of the upper half part 23 is pressed against the third positioning protrusion 342 and the fourth positioning protrusion 343; and the top of the upper half part 23 is pressed against the sixth positioning protrusion 346. Further, the upper half part 23 has a first upper surface 233 and a first lower surface 234; both the first upper surface 233 and the first lower surface 234 are flat surfaces; the fifth positioning protrusion 146 and the sixth positioning protrusion 346 are pressed against the first upper surface 233; and one side of the first positioning protrusion 142, one side of the second positioning protrusion 143, one side of the third positioning protrusion 342, and one side of the fourth positioning protrusion 343 are pressed against the first lower surface 234. Much further, the lower half part 24 has a second upper surface 241 and a second lower surface 242; the second upper surface 241 is a flat surface, and the second lower surface 242 is an arc-shaped surface; the other side of the first positioning protrusion 142, the other side of the second positioning protrusion 143, the other side of the third positioning protrusion 342, and the other side of the fourth positioning protrusion 343 are all pressed against the second upper surface 241; and the first guide slot 25 is arranged on the first lower surface 234. Through the above structure, due to the arrangement of the first positioning slot 144, the second positioning slot 145, the third positioning slot 344, and the fourth positioning slot 345, it can be convenient for a user to precisely and quickly mount the upper half part 23 and the lower half part 24 on the first connecting rod unit 1 and the second connecting rod unit 3, so that the upper half part 23 and the lower half part 24 combine the first connecting rod unit 1 with the second connecting rod unit 3 into a whole.

In this embodiment, the connecting rod piece further includes a curtain 8, wherein a first insertion port 311 is arranged at an end portion of the first mounting slot 11 and/or an end portion of the second mounting slot 31; the curtain 8 has a shading part 81 and a mounting bar 82; the shading part 81 is connected to the mounting bar 82; the mounting bar 82 is placed into the mounting channel 4 through the first mounting slot 11, the first guide slot 25, and the second mounting slot 31 through the first insertion port 311 in sequence; a first avoidance notch 312 is arranged in axial directions of the first mounting slot 11, the first guide slot 25, and the second mounting slot 31; and the first avoidance notch 312 is configured to avoid the shading part 81. An upper side of the shading part 81 is connected to the shading part 81 after being bent to form an accommodating chamber 811, and the mounting bar 82 is arranged in the accommodating chamber 811. Specifically, the shading part 81 is a flexible shading part 81, and the mounting bar 82 is a flexible mounting bar 82. Through the above structure, the mounting bar 82 of the curtain 8 can be inserted into the first insertion port 311, and the first avoidance notch 312 can allow the shading part 81 to slide along with the mounting bar 82 in the first insertion port, so as to complete the mounting of the curtain 8. Furthermore, the shading part 81 is a flexible shading part 81, and the mounting bar 82 is a flexible mounting bar 82. When transportation and storage are required, the shading part 81 and the mounting bar 82 can be folded for storage and transportation, which further reduces the transportation cost. Furthermore, when no shading is required, the flexible shading part 81 can be rolled up; when the shading part 81 needs to be used, the shading part is then unfolded for use. The operation is convenient, and usage requirements of a user in different scenarios can be met.

In this embodiment, cross sections of the first mounting slot 11, the second mounting slot 31, and the first guide slot 25 are circular. The connecting device 2 is a plastic connecting device 2 or a metal connecting device 2. Specifically, the first connecting rod unit 1 is a first metal connecting rod unit, and the second connecting rod unit 3 is a second metal connecting rod unit. Further, a third stop edge 3121 is arranged at the first avoidance notch 312, and the third stop edge 3121 is configured to stop the mounting bar 82 in the first mounting slot 11 and the second mounting slot 31, to prevent the mounting bar 82 from sliding out of the first mounting slot 11 and the second mounting slot 31 through the first avoidance notch 312.

One or more implementation modes are provided above in combination with specific contents, and it is not deemed that the specific implementation of the present disclosure is limited to these specifications. Any technical deductions or replacements approximate or similar to the method and structure of the present disclosure or made under the concept of the present disclosure shall fall within the scope of protection of the present disclosure.

What is claimed is:

1. A connecting rod piece, comprising:
a hollow first connecting rod unit, wherein a side wall of the first connecting rod unit is provided with a first mounting slot;
a connecting device, wherein the connecting device has a first end and a second end; and
a hollow second connecting rod unit, wherein a side wall of the second connecting rod unit is provided with a second mounting slot; the first end of the connecting device is detachably connected to the first connecting rod unit, and the second end of the connecting device is detachably connected to the second connecting rod unit; the first mounting slot and the second mounting slot are communicated in sequence to form a mounting channel; and the mounting channel is configured to mount a curtain.

2. The connecting rod piece according to claim 1, wherein the first connecting rod unit has a first inner surface and a first outer surface; a first protrusion and a second protrusion are arranged on the first inner surface in a protruding manner; and the first protrusion and the second protrusion are respectively located on left and right sides of the first inner surface.

3. The connecting rod piece according to claim 2, wherein the connecting device comprises an upper half part and a lower half part; a first positioning slot is formed among the first positioning protrusion, the second positioning protrusion, and an upper side of the first inner surface; a second positioning slot is formed among the first positioning protrusion, the second positioning protrusion, and a lower side of the first inner surface; one end of the upper half part is inserted into the first positioning slot; and one end of the lower half part is inserted into the second positioning slot.

4. The connecting rod piece according to claim 1, wherein the connecting device comprises an upper half part and a lower half part; the connecting rod piece further comprises a third locking member; one end of the third locking member is provided with a third external thread; another end of the third locking member is provided with a third nut; the upper half part is further provided with a fifth mounting hole; the fifth mounting hole is internally provided with a third internal thread; the third external thread is connected to the third internal thread, and one end of the third locking member is compressed to the lower half part, to form a gap between the upper half part and the lower half part to compress the lower half part and the upper half part to an inner wall of the first connecting rod unit and an inner wall of the second connecting rod unit; a stop protrusion is further arranged on a side wall of the connecting device; and the fifth mounting hole is provided in the stop protrusion.

5. The connecting rod piece according to claim 1, wherein the first connecting rod unit has a first mounting opening; the second connecting rod unit has a second mounting opening; the first end of the connecting device is inserted into the first mounting opening, and the second end of the connecting device is inserted into the second mounting opening, to enable the connecting device to combine the first connecting rod unit with the second connecting rod unit into a whole; a stop protrusion is further arranged on a side wall of the connecting device; the stop protrusion is located between the first end and the second end; one side of the stop protrusion is stopped at the first mounting opening; and another side of the stop protrusion is stopped at the second mounting opening.

6. The connecting rod piece according to claim 5, wherein a length of the first end and a length of the second end are both greater than a length of the stop protrusion; and a width of the first end and a width of the second end are both less than a width of the stop protrusion.

7. The connecting rod piece according to claim 5, wherein a length range of the connecting device is 5 mm to 500 mm; a width range of the connecting device is 10 mm to 60 mm; and a length range of the stop protrusion is 1 mm to 80 mm.

8. The connecting rod piece according to claim 1, wherein the connecting device comprises an upper half part and a lower half part; and the upper half part and/or the lower half part has a weight reducing groove.

9. The connecting rod piece according to claim 8, wherein a first reinforcing rib is provided inside the weight reducing groove; the first reinforcing rib divides the weight reducing groove into at least two groove units; and the at least two groove units are arranged in sequence in a length direction of the connecting device.

10. The connecting rod piece according to claim 9, wherein a second reinforcing rib is provided inside the weight reducing groove; the first reinforcing rib and the second reinforcing rib are crosswise arranged; the first reinforcing rib and the second reinforcing rib divide the weight reducing groove into at least four groove units; and the at least four groove units are arranged in sequence in length and width directions of the connecting device.

11. The connecting rod piece according to claim 9, wherein a thickness range of the first reinforcing rib is 1 mm to 40 mm; a length range of the weight reducing groove is 1 mm to 300 mm; a width range of the weight reducing groove is 1 mm to 300 mm; and a depth range of the weight reducing groove is 1 mm to 40 mm.

12. The connecting rod piece according to claim 1, wherein the connecting rod piece is an aluminum alloy connecting rod piece, an iron connecting rod piece, a plastic connecting rod piece, a stainless steel connecting rod piece, a copper connecting rod piece, a zinc alloy connecting rod piece, a copper alloy connecting rod piece, an alloy steel connecting rod piece, or an aluminum-plastic composite connecting rod piece; and the connecting device is a plastic connecting device or a metal connecting device.

13. The connecting rod piece according to claim 1, wherein a length of the first connecting rod unit and a length of the second connecting rod unit are both greater than a length of the connecting device; and a sum of a weight of the first connecting rod unit and a weight of the second connecting rod unit is greater than a weight of the connecting device.

14. The connecting rod piece according to claim 1, wherein hardness of the first connecting rod unit and hardness of the second connecting rod unit are greater than hardness of the connecting device.

15. The connecting rod piece according to claim 1, wherein a ratio of a length of the first connecting rod unit to a length of the connecting device is at least 1:1, and a ratio of a length of the second connecting rod unit to a length of the connecting device is at least 1:1.

16. The connecting rod piece according to claim 5, wherein an inner diameter range of the first mounting opening is 20 mm to 80 mm; a width of the stop protrusion is greater than an inner diameter of the first mounting opening; a length of the first connecting rod unit is greater than a length of the first end, to enable the first connecting rod unit to completely wrap around the first end; a length of the second connecting rod unit is greater than a length of the second end, to enable the second connecting rod unit to completely wrap around the second end; and when the connecting device combines the first connecting rod unit with the second connecting rod unit into a whole, a length of the connecting rod piece is at least a sum of the length of the first connecting rod unit, the length of the second connecting rod unit, and the length of the stop protrusion.

17. The connecting rod piece according to claim 8, wherein the weight reducing groove is square, rectangular, circular, elliptical, triangular, semicircular, polygonal, star-shaped, heart-shaped, or steplike.

18. The connecting rod piece according to claim 1, wherein the connecting device comprises an upper half part and a lower half part; the lower half part is provided with a first guide slot; the first mounting slot, the first guide slot, and the second mounting slot are communicated in sequence to form the mounting channel; the mounting channel is configured to mount the curtain; and a thickness of a middle portion of the lower half part is less than a thickness on each of two sides of the lower half part.

19. The connecting rod piece according to claim 1, wherein the connecting device comprises an upper half part and a lower half part; the upper half part has a weight reducing groove; and the lower half part is a solid lower half part.

20. The connecting rod piece according to claim 1, wherein the first connecting rod unit has a first mounting opening; the second connecting rod unit has a second mounting opening; the first end of the connecting device is inserted into the first mounting opening, and the second end of the connecting device is inserted into the second mounting opening, to enable the connecting device to combine the first connecting rod unit with the second connecting rod unit into a whole; the connecting device comprises an upper half part and a lower half part; a middle portion of the upper half part is connected to a middle portion of the lower half part; a first gap exists between one end of the upper half part and one end of the lower half part; a second gap exists between another end of the upper half part and another end of the lower half part; a first mounting hole is provided in the first end of the connecting device; a second mounting hole is provided in the second end of the connecting device; a third mounting hole is provided in the first connecting rod unit; a fourth mounting hole is provided in the second connecting rod unit; the connecting rod piece further comprises a first locking member; the first locking member detachably locks the first end of the connecting device to the first connecting rod unit; the connecting rod piece further comprises a second locking member; the second locking member detachably locks the second end of the connecting device to the second connecting rod unit; the first mounting hole has a first internal thread inside; the second mounting hole has a second internal thread inside; one end of the first locking member has a first external thread; one end of the second locking member has a second external thread; when the first external thread of the first locking member passes through the third mounting hole and the first mounting hole in sequence and is connected to the first internal thread, one end of the first locking member compresses the upper half part to the lower half part, to expand the first gap between the upper half part and the lower half part to compress the lower half part and the upper half part to an inner wall of the first connecting rod unit; and when the second external thread of the second locking member passes through the fourth mounting hole and the second mounting hole in sequence and is connected to the second internal thread, one end of the second locking member compresses the upper half part to the lower half part, to expand the second gap between the upper half part and the lower half part to compress the lower half part and the upper half part to an inner wall of the second connecting rod unit.
